(19) United States
(12) Patent Application Publication
(10) Pub. No.: US 2017/0061366 A1
(43) Pub. Date: Mar. 2, 2017

(54) METHODS AND APPARATUS FOR PROCESSING AND GENERATING AN ORDER

(71) Applicant: MasterCard International Incorporated, Purchase, NY (US)

(72) Inventors: Lokesh Rajput, Gurgaon (IN); Vikhyat Shukla, Gurgaon (IN); Piyush Dixit, New Delhi (IN)

(21) Appl. No.: 15/240,837

(22) Filed: Aug. 18, 2016

(30) Foreign Application Priority Data
Aug. 24, 2015 (SG) 10201506693R

(51) Int. Cl. G06Q 10/08; G06Q 30/06

(52) U.S. Cl. CPC G06Q 10/083; G06Q 30/0635

(57) ABSTRACT

A computer implemented method of processing an e-commerce order is provided. The method includes receiving, at an e-commerce server, an indication of an order including an indication of delivery information. The delivery information includes geolocation information and location specification information, the geolocation information includes latitude and longitude coordinates of the delivery destination, and the location specification information includes an indication of a vertical coordinate of the delivery destination. The method also includes generating delivery instructions for a courier to deliver at least one product to the delivery destination, the instructions comprising the geolocation information and the location specification information.

### CROSS REFERENCE TO RELATED APPLICATIONS

This application claims the benefit of Singapore Patent Application No. 10201506693R filed Aug. 24, 2015, which is hereby incorporated by reference in its entirety.

### BACKGROUND

The present disclosure relates to methods and systems for processing an order such as an e-commerce order. In particular, the disclosure relates to the provision of delivery information which uniquely identifies a delivery destination for an order.

The trading of goods and services over computer networks such as the internet is known as electronic commerce (e-commerce). The use of e-commerce continues to grow rapidly. A typical e-commerce transaction involves a consumer ordering a product from an on-line retailer and then receiving delivery of the product from a courier. The delivery of the product to the consumer relies on the courier being able to identify accurately the delivery destination for the product. In current e-commerce systems this is achieved by the consumer providing a delivery address.

In many cases, the provision of a delivery address is sufficient to allow the courier to identify the delivery destination. In some cases however, the provision of a delivery address may not be sufficient to allow the courier to identify the delivery destination. This is often the case in developing countries where individual dwellings are not always uniquely identifiable by a street address.

Therefore, it is desirable to provide a method of specifying a delivery destination that allows a courier to uniquely identify a delivery destination.

### BRIEF DESCRIPTION

In general terms, the present disclosure proposes to specify a delivery location using geolocation information in combination with other location specification information, which together allow the delivery destination to be uniquely identified.

According to a first aspect, there is provided a computer-implemented method for processing an e-commerce order. The method includes receiving, at an e-commerce server, an indication of an order including an indication of at least one product and an indication of delivery information. The delivery information includes geolocation information and location specification information, the geolocation information includes latitude and longitude coordinates of the delivery destination, and the location specification information includes an indication of a vertical coordinate of the delivery destination. The method also includes generating delivery instructions for a courier to deliver the at least one product to the delivery destination. The instructions include the geolocation information and the location specification information.

The vertical coordinate of the delivery destination may be an indication of a floor or level of the delivery destination.

In an embodiment, the location specification information includes at least one of an image, a video, and a description of the delivery destination.

According to a second aspect, there is provided computer implemented method of processing an e-commerce order. The method includes receiving, at an e-commerce server, an indication of an order including an indication of at least one product and an indication of delivery information. The delivery information includes geolocation information and location specification information, the location specification information includes at least one of an image, a video, and a description of the delivery location. The method also includes generating delivery instructions for a courier to deliver the at least one product to the delivery destination. The instructions include the geolocation information and the location specification information.

According to a third aspect, there is provided computer implemented method of processing an e-commerce order. The method includes receiving, at an e-commerce server, an indication of an order including an indication of at least one product and an indication of delivery information. The indication of delivery information includes an indication of an entry in a delivery information database. The method also includes looking up delivery information in the delivery information database using the indication. The delivery information includes geolocation information and location specification information, which in combination uniquely identify a delivery location. The method further includes generating delivery instructions for a courier to deliver the at least one product to the delivery destination. The instructions include the geolocation information and the location specification information.

According to a fourth aspect, there is provided a computer implemented method of generating an e-commerce order on a communication device. The method includes receiving a user input specifying at least one product, determining a geolocation of the communication device, generating geolocation information indicating the latitude and longitude coordinates of the geolocation of the communication device, and receiving a user input of location specification information. The location specification information includes an indication of a vertical coordinate of the delivery destination. The method further includes sending an order to an e-commerce server. The order includes an indication of the at least one product and delivery information includes the geolocation information and the location specification information.

The methods may be implemented by, for example, a server or a communications device having a computer processor and data storage device storing software components or instructions to carry out the operations disclosed above.

According to a yet further aspect, there is provided a non-transitory computer-readable medium. The computer-readable medium has stored thereon program instructions for causing at least one processor to perform operations of a method disclosed above.

The term “communication device” refers a piece of equipment or hardware which is capable of transmitting and receiving data electronically. It may be a computer device such as a mobile phone (e.g. smartphones or conventional/feature phones), a tablet, a desktop computer, a laptop computer or a smart watch etc.

### BRIEF DESCRIPTION OF THE DRAWINGS

Embodiments of the invention will now be described as of non-limiting examples only, with reference to the following drawings in which:

FIG. 1 illustrates an apparatus according to an embodiment;

FIG. 2 is a block diagram illustrating a technical architecture of the apparatus according to an embodiment;

FIG. 3 is a block diagram illustrating a technical architecture of a communications device according to an embodiment;

FIG. 4 is a flow diagram illustrating process steps which are performed by an e-commerce server during processing of an e-commerce order; and

FIG. 5 is a flow diagram illustrating process steps which are performed by a communication device during generation of an e-commerce order.

### DETAILED DESCRIPTION

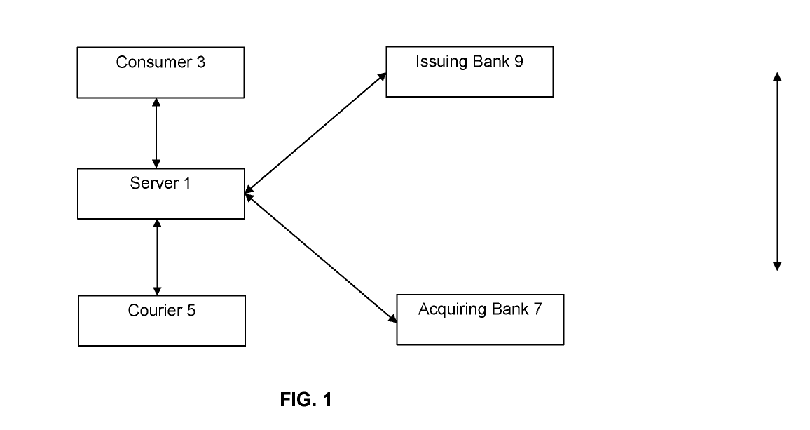

FIG. 1 illustrates an apparatus 1 for processing an e-commerce order from a consumer 3. The order is delivered by a courier 5 that receives delivery instructions from an e-commerce server 1.

The server 1 is provided to communicate with the consumer 3 and the courier 5. Optionally, as described below, the server 1 may be also in communication with an issuing bank 9 of the consumer 3 and an acquiring bank 7 of the merchant. Generally, the server 1 may be configured to handle requests and/or communications from terminals associated with parties involved in a transaction carried out over an e-commerce network. The e-commerce network can be any electronic payment network which connects, directly and/or indirectly payers (consumers and/or their banks or similar financial institutions) with payees (the merchants and/or their banks or similar financial institutions). A non-limiting example of an e-commerce network is a payment card network, such as the payment processing network operated by MasterCard. The various communication may take place via any types of network, for example, virtual private network (VPN), the Internet, a local area and/or wide area network (LAN and/or WAN), and so on.

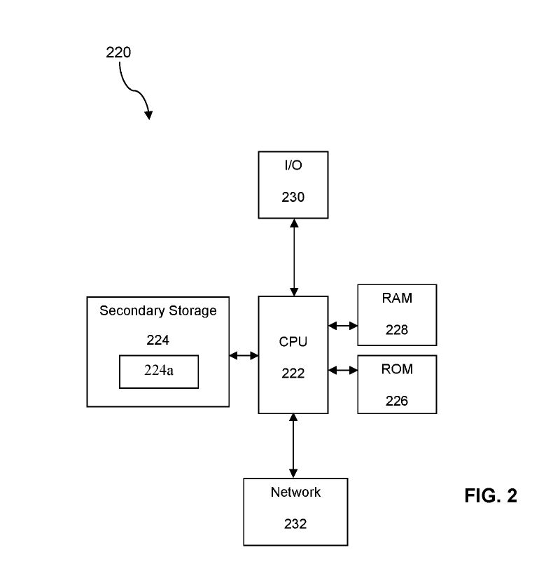

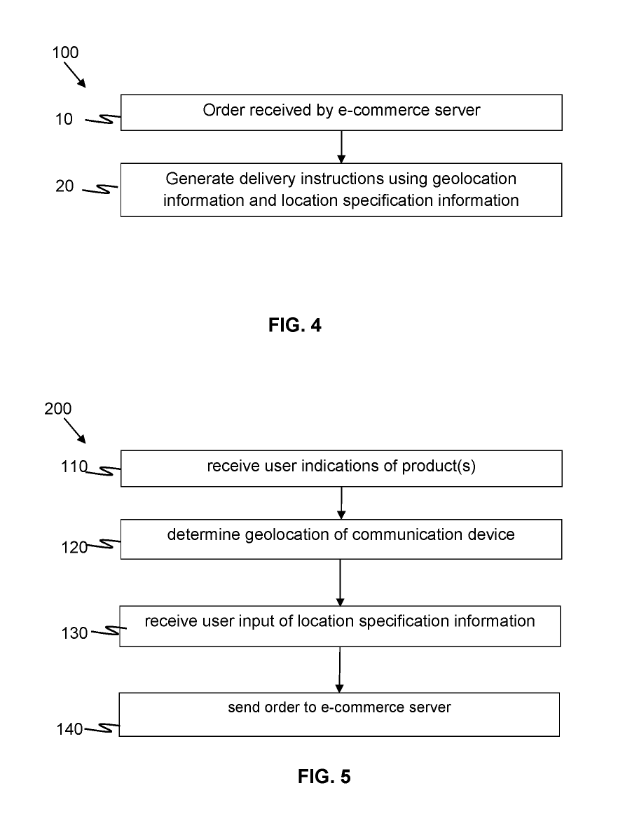

FIG. 2 is a block diagram showing a technical architecture of the server 1 for performing an exemplary method 100 which is described below with reference to FIG. 4. Typically, the method 100 is implemented by a computer having a data-processing unit. The block diagram as shown FIG. 2 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further include input/output (I/O) devices 230, and network connectivity devices 232.

The secondary storage 224 may include one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a including non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

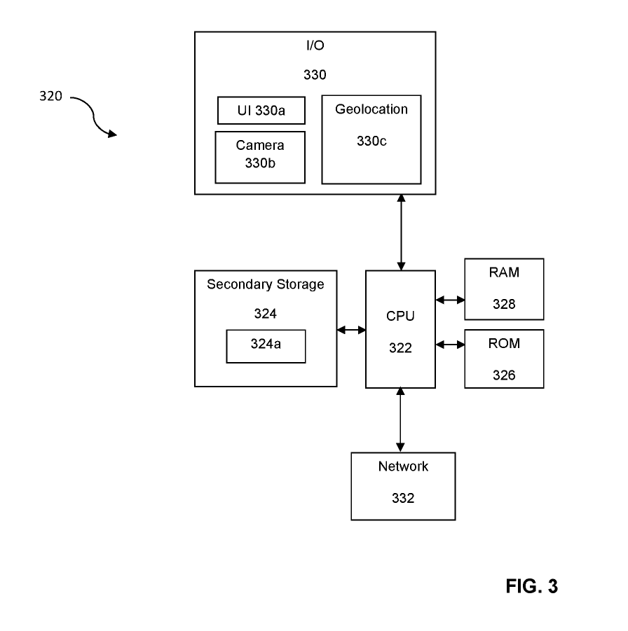

FIG. 3 is a block diagram showing a technical architecture of the consumer device 3 for performing an exemplary method 200 which is described below with reference to FIG. 5. Typically, the method 200 is implemented by a communication device having a data-processing unit. It is envisaged that in embodiments, the communication device will be a smartphone or tablet device. The block diagram as shown FIG. 3 illustrates a technical architecture 320 of a communication device which is suitable for implementing one or more embodiments herein.

The technical architecture 320 includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture 320 further includes input/output (I/O) devices 330, and network connectivity devices 332.

The I/O devices include a user interface (UI) 330a, a camera 330b and a geolocation module 330c. The UI 330a may include a touch screen, keyboard, keypad or other known input device. The camera 330b allows a user to capture images and/or videos and save the captured images and videos in electronic form. The geolocation module 330c is operable to determine the geolocation of the communication device using signals from, for example global positioning system (GPS) satellites.

The secondary storage 324 may include of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has an order generation component 324a, including non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Various operations of exemplary methods 100 & 200 will now be described with reference to FIG. 4, in respect of processing an e-commerce order and operations in respect of placing an order by a consumer will be described with reference to FIG. 5. It should be noted that the enumeration of operations is for the purposes of clarity and the operations do not need to be performed in the order implied by the enumeration.

The method 100 shown in FIG. 4 is carried out by the e-commerce server 1.

At step 10, an order is received by the e-commerce server 1. The order includes an indication of at least one product and an indication of delivery information. The delivery information includes geolocation information and location specification information. The geolocation information and location specification information in combination allow a delivery destination to be uniquely identified. The order may also include invoice address information and/or delivery address information. The invoice address information may indicate a different address from the delivery address information. The delivery address information may form part of the delivery information.

The geolocation information may include latitude and longitude co-ordinates of a location generated by a geolocation device at the delivery destination. The location specification information includes information that at courier delivering the product to a consumer can use to uniquely identify the delivery destination.

Where the delivery destination is an apartment block or other building having multiple floors, the location specification information may include an indication of altitude such as a floor or level number to allow the courier to identify the correct floor to deliver the product. It is noted that a single geolocation may correspond to several apartments if the apartments are located vertically above one another.

In an alternative embodiment, the delivery specification information may include a description, an image or a video of a building, door, gateway or other landmark that allows the courier to uniquely identify the delivery destination. The video may also include delivery information in visual, written and/or spoken form.

At step 20, the e-commerce server 1 generates delivery instructions using the geolocation information and the location specification information. The delivery instructions may be generated as a message which is sent to an electronic terminal associated with the courier. This electronic terminal may be coupled to navigation system in a vehicle which can be programmed to guide the courier to the geolocation. Alternatively the delivery instructions may be generated as a document.

The flowchart shown in FIG. 5 shows the method carried out by the consumer device 3.

At step 110, the user inputs a product or selection of products using the user interface 330a of the device 320. At step 120 the geolocation module 330c determines the current location of the device 320. The current location of the device 320 may be determined by the geolocation module 330c as a latitude coordinate and a longitude coordinate. In one embodiment, the method 200 is implemented on a smartphone or tablet app on the device 320 running the Google Maps Service. In this embodiment, the geolocation of the device may be determined by accessing a Google application programming interface (API) indicating the location of the device 320.

At step 130, the device 320 receives input of the location specification information. As described above, the location specification information may include an indication of a floor or level number, in which case, the user inputs the indication using the user interface 330a. Alternatively, or additionally the location specification information may comprise an image or a video of, for example a building, a door, a gateway or other landmark captured by the camera 330b of the device 320. The location specification information may comprise a description to assist the courier in locating the delivery destination, in which case the user enters the description using the user interface 330a.

At step 140, an indication of the order is sent to the e-commerce server 1. The indication of the order includes an indication of the product or products selected by the user, an indication of the geolocation of the device 320 and the location specification information.

In the embodiments described above, geolocation information and location specification information are sent with an order to the e-commerce server. In an alternative embodiment, the order may include an indication of a delivery destination previously provided by the consumer. The e-commerce server may be coupled to a database storing delivery destination indications each including geolocation information and location specification information. The delivery destination indications may be stored linked to payment card details to allow a consumer to select a previously used delivery destination indication without having to re-enter the details. Alternatively, the delivery destination indications may be linked to unique numbers or character sequences. This would again allow the consumer to submit orders without having to re-enter all of the delivery destination details. Further, the consumer could also request orders to be delivered to locations other than their current location at the time of making the order. For example a consumer could make and order from home and request that it be delivered to their workplace. This would also allow a consumer to provide their delivery details to other parties to allow delivery of gifts, for example. This could be achieved by the gift recipient providing the unique number or character sequence linked to their delivery destination. The delivery destination details of the gift recipient may be stored in a database. The e-commerce server may provide for customers to register their details as first time users. This registration may take place at the same time as an order or may take place separately. In some embodiments, a customer may submit the order by telephone or post. For example once a delivery location has been registered, the customer may receive a code usable by the e-commerce server to look up the delivery information. It is envisaged that the code may be supplied as part of a mail or telephone order as an alternative to an electronic order.

In addition to the location specification information, the consumer may also provide additional information to assist the courier such as details of the availability of stairs or elevators at the delivery location, availability of parking near the delivery location, and details of required timing for the delivery, for example the availability of a person to receive the delivery at the delivery location. The additional information may also include details on the area surrounding the delivery location such as traffic information and the availability of facilities such as gas stations in the area.

Whilst the foregoing description has described exemplary embodiments, it will be understood by those skilled in the art that many variations of the embodiment can be made within the scope and spirit of the present disclosure.

1. A computer implemented method of processing an e-commerce order, said method comprising:
receiving, at an e-commerce server, an indication of an order comprising an indication of at least one product and an indication of delivery information, the delivery information comprising geolocation information and location specification information, the geolocation information comprising latitude and longitude coordinates of the delivery destination, the location specification information comprising an indication of a vertical coordinate of the delivery destination; and
generating delivery instructions for a courier to deliver the at least one product to the delivery destination, the instructions comprising the geolocation information and the location specification information.

2. A method according to claim 1, wherein the indication of a vertical coordinate of the delivery destination is an indication of at least one of a floor and a level of the delivery destination.

3. A method according to claim 1, wherein the location specification information further comprises at least one of an image, a video, and a description of the delivery destination.

4. A non-transitory computer-readable medium having stored thereon program instructions for causing at least one processor to perform the method in accordance with claim 1.

5. A computer implemented method of processing an e-commerce order, said method comprising:
receiving, at an e-commerce server, an indication of an order comprising an indication of at least one product and an indication of delivery information, the delivery information comprising geolocation information and location specification information, the location specification information comprising at least one of an image and a video of the delivery location; and
generating delivery instructions for a courier to deliver the at least one product to the delivery destination, the instructions comprising the geolocation information and the location specification information.

6. A method according to claim 5, wherein the geolocation information comprises latitude and longitude coordinates of the delivery destination and the location specification information comprises an indication of a vertical coordinate of the delivery destination.

7. A method according to claim 6, wherein the indication of the vertical coordinate of the delivery destination is an indication of at least one of a floor and a level of the delivery destination.

8. A non-transitory computer-readable medium having stored thereon program instructions for causing at least one processor to perform the method in accordance with claim 5.

9. A computer implemented method of processing an e-commerce order, said method comprising:
receiving, at an e-commerce server, an indication of an order comprising an indication of at least one product and an indication of delivery information, the indication of delivery information comprising an indication of an entry in a delivery information database;
looking up delivery information in the delivery information database using the indication, the delivery information comprising geolocation information and location specification information, which in combination uniquely identify a delivery location; and
generating delivery instructions for a courier to deliver the at least one product to the delivery destination, the instructions comprising the geolocation information and the location specification information.

10. A method according to claim 9, wherein the geolocation information for an entry in the database comprises latitude and longitude coordinates of a delivery location and the location specification information comprises an indication of a vertical coordinate of the delivery location.

11. A method according to claim 9, wherein the location specification information for an entry in the database comprises at least one of an image, a video, and a description of a delivery location.

12. A non-transitory computer-readable medium having stored thereon program instructions for causing at least one processor to perform the method in accordance with claim 9.

13. A computer implemented method of generating an e-commerce order on a communication device, said method comprising:
receiving a user input specifying at least one product;
determining a geolocation of the communication device;
generating geolocation information indicating the latitude and longitude coordinates of the geolocation of the communication device;
receiving a user input of location specification information, the location specification information comprising an indication of a vertical coordinate of the delivery destination; and
sending an order to an e-commerce server, the order comprising an indication of the at least one product and delivery information comprising the geolocation information and the location specification information.

14. A method according to claim 13, wherein the indication of a vertical coordinate of the delivery destination is an indication of at least one of a floor and a level of the delivery destination.

15. A method according to claim 13, wherein receiving a user input of location specification information comprises receiving user control signals to capture at least one of an image, and a video, wherein the location specification information comprises the captured image or a video.

16. A method according to claim 13, wherein the user input of location specification information comprises a description of the delivery destination.

17. A non-transitory computer-readable medium having stored thereon program instructions for causing at least one processor to perform the method in accordance with claim 13.

18. An apparatus for processing an e-commerce order comprising:
a processor and a data storage device, the data storage device having a transaction order processing component comprising non-transitory instructions that cause the processor to:
(a) receive an indication of an order comprising an indication of at least one product and an indication of delivery information, the delivery information comprising geolocation information and location specification information, wherein the geolocation information comprises latitude and longitude coordinates of the delivery destination and the location specification information comprises an indication of a vertical coordinate of the delivery destination; and
(b) generate delivery instructions for a courier to deliver the at least one product to the delivery destination, the instructions comprising the geolocation information and the location specification information.

19. An apparatus according to claim 18, wherein the indication of a vertical coordinate of the delivery destination is an indication of at least one of a floor and a level of the delivery destination.

20. An apparatus according to claim 18, wherein the location specification information further comprises at least one of an image, a video, and a description of the delivery destination.

21. An apparatus for processing an e-commerce order comprising:
a processor and a data storage device, the data storage device having a transaction order processing component comprising non-transitory instructions that cause the processor to:
(a) receive an indication of an order comprising an indication of at least one product and an indication of delivery information, the delivery information comprising geolocation information and location specification information, the location specification information comprising at least one of an image and a video of the delivery location; and
(b) generate delivery instructions for a courier to deliver the at least one product to the delivery destination, the instructions comprising the geolocation information and the location specification information.

22. An apparatus according to claim 21, wherein the geolocation information comprises latitude and longitude coordinates of the delivery destination and the location specification information further comprises an indication of a vertical coordinate of the delivery destination.

23. An apparatus according to claim 22, wherein the indication of the vertical coordinate of the delivery destination is an indication of at least one of a floor and a level of the delivery destination.

24. An apparatus for processing an order comprising:
a processor;
a data storage device;
and a database, the database storing a plurality of delivery information entries, each delivery information entry comprising geolocation information and location specification information, which in combination uniquely identify a delivery location, the data storage device having a transaction order processing component comprising non-transitory instructions that cause the processor to:
(a) receive an indication of an order comprising an indication of at least one product and an indication of delivery information, the indication of delivery information comprising an indication of an entry in a database;
(b) look up delivery information in the database using the indication; and
(c) generate delivery instructions for a courier to deliver the at least one product to the delivery destination, the instructions comprising the geolocation information and the location specification information.

25. An apparatus according to claim 24, wherein the geolocation information for an entry in the database comprises latitude and longitude coordinates of the delivery location and the location specification information comprises an indication of a vertical coordinate of the delivery location.

26. An apparatus according to claim 24, wherein the location specification information for an entry in the database comprises at least one of an image, a video, and a description of the delivery location.

27. A communication device comprising:
a processor and a data storage device, the data storage device having a transaction order processing component comprising non-transitory instructions that cause the processor to:
receive a user input specifying at least one product;
determine a geolocation of the communication device;
generate geolocation information indicating the latitude and longitude coordinates of the geolocation of the communication device;
receive a user input of location specification information, the location specification information comprising an indication of a vertical coordinate of the delivery destination; and
send an order to an e-commerce server, the order comprising an indication of the at least one product and delivery information comprising the geolocation information and the location specification information.

28. A communication device according to claim 27, wherein the indication of a vertical coordinate of the delivery destination is an indication of at least one of a floor and a level of the delivery destination.

29. A communication device according to claim 27, further comprising a camera, and wherein the user input of location specification information comprises user control signals to capture at least one of an image and a video, wherein the location specification information comprises the captured image or video.

30. A communication device according to claim 27, wherein the user input of location specification information further comprises a description of the delivery destination.
